(19) United States
(12) Patent Application Publication
(10) Pub. No.: US 2008/0213540 A1
(43) Pub. Date: Sep. 4, 2008

(54) FLOOR MAT AND METHOD OF MANUFACTURE

(75) Inventors: William G. Alford, Canton, OH (US); Jessie M. Martin, Millersburg, OH (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 11/972,883

(22) Filed: Jan. 11, 2008

Related U.S. Application Data
(60) Provisional application No. 60/884,473, filed on Jan. 11, 2007.

(51) Int. Cl. B32B 3/00; B27N 3/08

(52) U.S. Cl. 428/156; 264/239

(57) ABSTRACT

A floor mat having a first layer and a second layer. The second layer has a hinge that at least partially separates the second layer into a body section and a flap section. The hinge allows the flap section to be folded relative to the body section.

### CROSS-REFERENCE TO RELATED APPLICATIONS

This application claims the benefit of U.S. provisional application Ser. No. 60/884,473 filed Jan. 11, 2007.

### BACKGROUND OF THE INVENTION

1. Field of the Invention

The present invention relates to a floor mat and a method of manufacture for a floor mat.

### SUMMARY OF THE INVENTION

In at least one embodiment of the present invention a floor mat is provided. The floor mat includes a first layer and a second layer disposed proximate the first layer. The second layer has a hinge that at least partially separates the second layer into a body section and a flap section. The hinge permits the flap section to be folded relative to the body section.

In at least one other embodiment of the present invention a floor mat for a motor vehicle is provided. The floor mat includes a unitary backing layer and a carpet layer. The unitary backing layer has a first surface, a second surface disposed opposite the first surface, and a hinge provided as an indentation line that extends along the second surface. The carpet layer is disposed on the first surface. The hinge divides the backing layer into a body section and a first flap section and facilitates folding of the first flap section relative to the body section.

In another embodiment of the present invention, a method of making a floor mat is provided. The method includes providing a carpet layer and molding a backing layer on the carpet layer such that the backing layer includes an indentation line that defines a hinge.

### BRIEF DESCRIPTION OF THE DRAWINGS

FIG. 1 is a perspective view of an exemplary floor mat in a folded configuration.

FIG. 2 is a top plan view of the floor mat of FIG. 1.

FIG. 3 is a section view of the floor mat along section line 3-3.

FIG. 4 is a section view of another embodiment of a floor mat having a hinge provided as a separate component.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

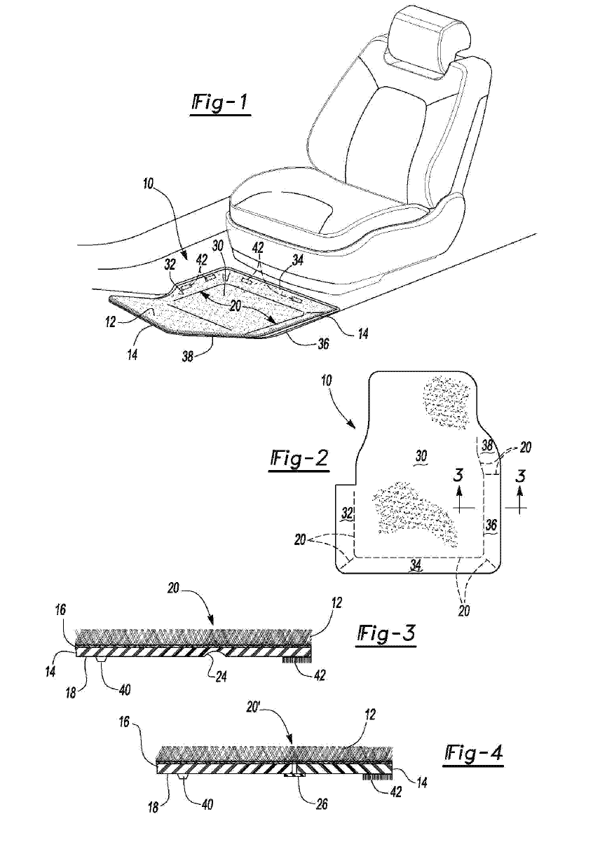

Referring to FIG. 1, and exemplary floor mat 10 in accordance with the present invention is shown. The floor mat 10 may be provided for use with a vehicle, such as a car or truck. For example, the floor mat 10 may be designed to fit and at least partially conceal a vehicle floor and one or more surrounding surfaces or components, such as a transmission hump, door sill hump, or floor console as will be described in more detail below. As such, the floor mat 10 may offer enhanced protection of vehicle interior carpeting compared to traditional mats.

The floor mat 10 may have any suitable configuration. For example, the floor mat 10 may include one or more layers. In at least one embodiment, the floor mat 10 may include a first layer 12 and a second layer 14.

The first layer 12 may be provided as a top layer of the floor mat 10. The first layer 12 may be made of any suitable material or materials. For example, the first layer 12 may be at least partially made of a flexible material such as carpet or a polymeric material. In addition, the first layer 12 may include one or more features that capture fluids and/or inhibit wear, such as localized polymeric regions that may be disposed in locations that may be frequently contacted by a foot of a vehicle occupant.

The second layer 14 or backing layer may be disposed proximate the first layer 12. As is best shown in FIG. 3, the second layer 14 may include a first surface 16 that directly contacts the first layer 12 and a second surface 18 disposed opposite the first surface 16. The second layer 14 may be provided on the first layer 12 in any suitable manner, such with a molding process like compression molding or using an adhesive. The second layer 14 may be made of any suitable material. For example, the second layer 14 may be made of a polymeric or rubber material that provides sufficient support for the first layer 12. Alternatively, the first layer 12 may be at least partially spaced apart from the second layer 14 by one or more intermediate layers. For example, a foam insert may be disposed between the first and second layers 12,14 to provide increased padding and/or help provide a desired shape.

One or more hinges 20 may be provided with the second layer 14 to facilitate localized folding and/or positioning of the floor mat 10. The hinges 20 may have any suitable configuration. For example, the hinges 20 may include one or more indentations that are integrally formed in the second layer 14. The hinges 20 may be generally configured as a line and may generally extend from one edge of the second layer 14 to another. The hinge 20 may be configured as an area of reduced material thickness on the second layer 14 to provide additional localized flexibility of the floor mat 10.

Alternatively, the hinge may be provided as a separate component as is shown in FIG. 4. As such, the hinge 20′ may be made of a material that differs from the adjacent portions of second layer, such as fabric or a polymeric material such as a flexible tape. In addition, a hinge 20′ may be molded into the second layer or may be attached to a surface of the second layer 14 in any suitable manner, such as with an adhesive, fastener, sewing, or bonding techniques, such as ultrasonic welding, sonic welding, heat bonding, etc. Moreover, the features of FIGS. 3 and 4 may be combined to provide a hinge that combines an indentation in the second layer with a separate hinge component.

Referring to FIGS. 1 and 2, a hinge 20, 20′ may help define or denote a boundary between different portions of the floor mat 10. For convenience, the hinges in FIGS. 1 and 2 are all denoted using reference number 20. In the embodiment shown in FIGS. 1 and 2, the floor mat 10 includes a body section 30 that is flexibly connected to four flaps 32, 34, 36, 38 that project from different sides of the body section 30. Of course the present invention contemplates that any suitable number of flaps may be provided to accommodate different vehicle floor configurations. Moreover, one flap, multiple flaps, or no flaps may extend from a side of the body section 30.

The flap(s) may be sized and structured to extend at an angle from the body section 30, such as generally upward or vertically from the body section 30, to at least partially cover and help protect a raised or contoured surface of the vehicle, like a door sill, console or transmission hump or other vertical or near vertical surface that extends from a vehicle floor. As such, the flaps may reduce soiling of these areas compared with a traditional floor mat that only covers the generally flat recessed area of a vehicle floor. In at least one embodiment, the flaps may help hold and retain contaminants on the floor mat and make it easier to remove a dirty mat without dropping debris in the vehicle.

At least one hinge may be disposed between one or more flaps. For example, a hinge 20,20′ may be disposed between adjacent flaps. Of course, adjacent flaps need not be connected by a hinge in one or more embodiments of the present invention. In embodiments having a hinge connecting one or more adjacent flaps, the floor mat 10 may be made with a bulge or additional material that permits the flaps to be folded relative to the body section without damage to one or more layers of the floor mat 10. For instance, the first and/or second layers 12,14 may be made with additional material that bulges when the floor mat 10 is generally flat, but is not generally apparent when the flaps are folded.

The hinges 20, 20′, whether provided between flaps or between a flap and the body section 30, may facilitate an easier transition from horizontal to vertical surfaces and may enable the floor mat to conform to sharp angles or contours to maintain generally gap free contact that may not be possible in a floor mat without hinges and flaps. Moreover, the hinges 20,20′ may or may not be concealed by the first layer 12 in one or more embodiments of the present invention.

The second surface 18 may include one or more retention features that help the floor mat 10 resist movement when installed in a vehicle. The retention features may be configured to engage a vehicle surface, such as vehicle carpeting. Different types of retention features may be provided in different areas of the floor mat 10. For instance, the body section 30 may include a first set of retention features 40, such as protrusions or nibs that dig into vehicle carpeting. One or more flaps may include a second set of retention features 42 that may have a different configuration than the first set of retention features 40 to provide better grip to a vertical or angled vehicle surface. For example, the second set of retention features 42 may be configured as a fastener, such as a hook, snap, or at least a portion of a hook and loop fastener that help maintain the position of the flap(s). A member of the second set of retention features 42 may be provided on the second surface 18 in any suitable manner. For example, a member of the second set of retention features 42 may be molded into or with the second layer 14 as an integral feature or provided as a separate component that is bonded to, molded with, sewn on, or otherwise attached to the second layer 14.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A floor mat comprising:
a first layer; and
a second layer disposed proximate the first layer, the first layer having a hinge that at least partially separates the first layer into a body section and a flap section and permits the flap section to be folded relative to the body section.

2. The floor mat of claim 1 wherein the second layer further comprises a first surface that faces the first layer and a second surface disposed opposite the first surface, wherein the hinge is provided as an indentation that extends from the second surface toward the first surface.

3. The floor mat of claim 1 wherein the hinge has reduced thickness than surrounding portions of the second layer.

4. The floor mat of claim 1 wherein the hinge is provided as a separate component that is attached to the second layer.

5. The floor mat of claim 3 wherein the hinge is provided as a separate component that is at least partially disposed in the second layer.

6. The floor mat of claim 1 wherein the hinge is made of a first material and the body and flap sections are made of a second material that differs from the first material.

7. The floor mat of claim 1 wherein the body section further comprises a first retention feature and the flap section further comprises a second retention feature that differs from the first retention feature, the first and second retention features being disposed on the second surface and adapted to engage a vehicle surface to inhibit movement of the floor mat.

8. The floor mat of claim 7 wherein the first retention feature is a nib that extends from the second surface and the second retention feature is a hook and loop fastener that is at least partially recessed into the second surface.

9. A floor mat for a motor vehicle, comprising:
a unitary backing layer including:
a first surface,
a second surface disposed opposite the first surface, and
a first hinge provided as an indentation line that extends along the second surface; and
a carpet layer disposed on the first surface;
wherein the first hinge divides the backing layer into a body section and a first flap section and facilitates folding of the first flap section relative to the body section.

10. The floor mat of claim 9 wherein the body section further comprises a first retention feature and the first flap section further comprises a second retention feature that differs from the first retention feature, the first and second retention features being disposed on the second surface and adapted to engage a vehicle surface to inhibit movement of the floor mat.

11. The floor mat of claim 9 further comprising a second hinge provided as an indentation line that extends along the second surface, wherein the second hinge divides the body section from a second flap section.

12. The floor mat of claim 11 wherein the first hinge is spaced apart from the second hinge.

13. The floor mat of claim 11 further comprising a first flap hinge disposed at an intersection of the first and second flap sections.

14. The floor mat of claim 13 wherein the first flap hinge is an indentation disposed on the second surface.

15. The floor mat of claim 10 further comprising a third hinge that extends along the second surface, wherein the third hinge divides the body section from a third flap section.

16. The floor mat of claim 15 further comprising a second flap hinge disposed at an intersection of the second and third flap sections.

17. The floor mat of claim 16 wherein the second retention feature is disposed on the third flap section and adapted to engage a vehicle surface to inhibit movement of the floor mat.

18. A method of making a floor mat, comprising:
providing a carpet layer; and
molding a backing layer on the carpet layer such that the backing layer includes an indentation that defines a hinge.

19. The method of claim 18 further molding a first retaining feature into a body section of the backing layer and providing a second retaining feature on a flap section of the backing layer, the flap section being at least partially separated from the body section by the hinge.

20. The method of claim 19 wherein the second retaining feature is provided as a separate component and is molded into the backing layer when the backing layer is molded on the carpet layer.
